(19) United States
(12) Patent Application Publication
(10) Pub. No.: US 2024/0430087 A1
(43) Pub. Date: Dec. 26, 2024

(54) ONE-WAY FUNCTIONS WITH POLYNOMIAL COMPUTATION

(71) Applicant: Arizona Board of Regents on Behalf of Northern Arizona University, Flagstaff, AZ (US)

(72) Inventors: Bertrand F. CAMBOU, Flagstaff, AZ (US); Jeffrey HOFFSTEIN, Flagstaff, AZ (US); Dina GHANAIMIANDOAB, Flagstaff, AZ (US); Nicholas NAVAZ, Flagstaff, AZ (US); Michael GARRETT, Flagstaff, AZ (US); Jack GARRARD, Flagstaff, AZ (US)

(21) Appl. No.: 18/442,951

(22) Filed: Feb. 15, 2024

Related U.S. Application Data
(63) Continuation-in-part of application No. 18/397,975, filed on Dec. 27, 2023.
(60) Provisional application No. 63/435,470, filed on Dec. 27, 2022.
(60) Provisional application No. 63/445,824, filed on Feb. 15, 2023.

(51) Int. Cl. H04L 9/30; H04L 9/32

(52) U.S. Cl. CPC H04L 9/3026; H04L 9/3278

(57) ABSTRACT

Methods for applying one-way functions for the purposes of cryptography and authentication are disclosed. The methods may be used in cryptographic systems relying on physical unclonable functions or the measurement of biological objects where repeated, sequential applications of one-way functions is required. Under the method, an input bitstream is received. The bitstream may optionally be expanded with a binary nonce and may be optionally transformed into a balanced ternary stream. A polynomial is generated having coefficients that are the values encoded in the stream. The polynomial is raised to a power to generate a second polynomial, and the coefficients of the second polynomial are read as an output stream.

### CROSS-REFERENCE TO RELATED APPLICATIONS

The present application is a continuation-in-part of U.S. patent application Ser. No. 18/397,975, entitled “Pseudo-Homomorphic Authentication of Users with Biometry,” filed Dec. 27, 2023, which claims priority to U.S. Provisional Application 63/435,470, entitled “Pseudo-Homomorphic Authentication of Users with Biometry,” filed Dec. 27, 2022. The present application also claims priority to U.S. Provisional Application No. 63/445,824, entitled “One Way Functions with Polynomial Computation,” filed on Feb. 15, 2023, all of which incorporated herein by reference in their entirety for all purposes.

### STATEMENT REGARDING FEDERALLY-SPONSORED RESEARCH

Not applicable.

### BACKGROUND

Information is frequently encrypted to protect against eavesdropping and unauthorized access using encryption schemes based on the use of one or more encryption keys and other keyless encryption schemes. Encryption schemes are frequently used in conjunction with authentication schemes to improve the security of electronic systems. The application of one-way cryptographic functions or “hashing” is an important feature of many cryptographic methods and is the basis of many methods of particular interest currently. In particular, Hash-based cryptography (HBC) has been suggested as a method for implementing strong encryption in the impending post-quantum era. HBC was initially suggested in the 1970s and 1980s by cryptographers such as Winternitz, Lamport, and Merkle, however, its impact was limited due to excessive latencies and key length. Most recently, Lattice cryptography with learning-with-errors (LWE) and NTRU (developed by Hoffstein, etl al.) is considered by the National Institute of Standards and Technology (NIST) to be the leading candidate for standardization for post-quantum cryptography (PQC). However, HBC is still an important scheme thanks to its strength to mitigate attacks based on quantum computers. NIST plans to keep the HBC implementation SPHINCS on the PQC roadmap as it continues to be a vibrant area of research.

Various co-assigned applications disclose systems and methods that are highly dependent on hashing and HBC, broadly defined. Many of these disclosures combine hashing with physical unclonable functions (PUFs) for cryptographic key generation. For example, co-assigned U.S. Pat. No. 11,496,326, filed on Jan. 27, 2021, entitled “Physical Unclonable Function-Based Encryption Schemes with Combination of Hashing Methods” describes a method of generating encryption keys on the basis of applying one-way cryptographic functions to measured responses of PUFs to particular stimulus. The disclosure of this application is incorporated herein by reference in its entirety for all purposes.

Co-assigned U.S. patent application Ser. No. 17/879,697, filed on Aug. 2, 2022, and published on Feb. 9, 2023, entitled “PUF-Protected Pseudo-Homomorphic Methods to Generate Session Keys” discloses a system that extensively uses one-way cryptographic functions. The disclosure of this application is incorporated herein by reference in its entirety for all purposes. This application discusses systems and methods for using physical unclonable functions (PUFs) to enable a user to authenticate a server, or a server to authenticate a user, and to generate session keys to enable authenticated communication between a client (user) and server. In one embodiment described in that application, the generation of session keys, initiated by client devices, is based on the use of PUFs embedded in the server. During an initial setup, the client device selects a set of passwords and a set of random numbers to hash the passwords multiple times. The server uses the resulting stream as a set of challenges to generate a set of responses from the PUF, which are stored as reference. To generate a session key, the client device picks a new set of random numbers which is smaller than the initial set of random numbers, to hash its password multiple times; the resulting messages are sent to the server. Using its PUF and the initial responses, the server can find the differences between both random numbers which are used to generate a shared session key. This method is pseudo-homomorphic because the computations never disclose the original passwords. Without the PUF, it is not possible to analyze the information and generate shared keys. The session keys may be used as or to generate encryption keys to support encrypted communication, authentication of communication sessions or other cryptographic functions.

A simple example of a scheme described in the aforementioned application is given by using two-steps. In the first step, a secret stream S₁ is hashed N times by a first person to generate the message digest M₁; N is a large natural number. The secret stream may be created with the assistance of a PUF, e.g., it may be a stream of PUF responses. A first party (e.g., a client or a server) completes a first step by communicating the message digest M₁ to a second party (e.g., a client or server). In this disclosure, the following notation is adopted:

M₁=H^{N}(S₁)

To digitally sign a stream D during a second step, the first party hashes or otherwise subject to a one-way function the same secret stream S₁, (N−n₁) times to generate the message digest M′₁; n₁ is a large natural number, n₁<N:

$${M}_{1}^{′} = {H}^{( N - {n}_{1} )} ( {S}_{1} )$$

The first party encrypts stream D with a cipher P that uses n₁ as a cryptographic key to generate the cipher text T. The first party sends to the second party the message digest M′₁, the cipher text T, and the stream D. To verify that the digital signature is valid, the second party finds n₁ by hashing M′₁ multiple times until the second party gets a message digest that matches M₁. At this point the second person has obtained n₁ and verifies that T is the cipher text of D, when encrypted by the cipher P, with n₁ as a cryptographic session key.

In this simple example, the public key is message digest M₁, and the private key is {S₁; N}; the information {M′₁; T} is a digital signature of D. Any third party observing the transaction will be able to verify that the signature is valid; However, only the first party can sign a document matching the message digest M₁.

The simple example described above may be expanded to be more advantageously used for cryptography. Examples of stronger implementations use k streams (e.g., k PUF response streams) {S₁; . . . ; Sₖ} that generate k initial message digests {M₁; . . . ; M₁}. To sign D, k natural numbers {n₁; . . . ; nₖ} are used as a shared cryptographic key, generating k message digests {M′₁; . . . ; M′ₖ}:

$${M}_{i}^{′} = {H}^{( N - {n}_{i} )} ( {S}_{i} ) with i ∈ \{ 1 to k \}$$

Additionally, similar methods that require sequential application of one-way functions used in conjunction with PUFs are disclosed in co-assigned U.S. patent application Ser. No. 17/954,222, filed on Sep. 27, 2022, published on Mar. 30, 2023, entitled “ASSOCIATIVE PUF ARRAYS TO GENERATE SESSION KEYS WITH PSEUDO-HOMOMORPHIC METHODS.” The entirety of this application is incorporated by reference herein for all purposes.

Additionally, co-assigned U.S. patent application Ser. No. 18/397,975, filed on Dec. 27, 2023, and entitled “Pseudo-Homomorphic Authentication of Users with Biometry,” extends the concepts disclosed in application Ser. No. 17/879,697 to the use of the measurement of biological structures to generate repeatable response streams (e.g., the secret stream S₁ described above) that can then be repeatedly provided to one-way functions for key generation. The entirety of application Ser. No. 18/397,975 is incorporated herein by reference for all purposes. That application describes the use of biometric prints (e.g., data about unique biological objects such as finger print or retinal data) to generate a different challenge-response-pair (CRP) mechanism that is added to the HBC protocol. The biometric images (with or without augmentation with PUFs) are used as CRP function f, transforming the incoming stream of challenges C into an outgoing stream of responses R:

R=f(C)

R is the response of challenge C. This is a one-way function (a physical one-way function) with a small probability of collision owing to the uniqueness of the biological object.

The second party uses the sets of initial message digests {M₁; . . . ; M₁}, and subsequent digests {M′₁; . . . ; M′₁} to generate sets of challenges {C₁; . . . ; Cₖ} and {C′₁; . . . ; C′ₖ}. With the CRP mechanism, these generate sets of responses {R₁; . . . ; Rₖ} and {R′₁; . . . ; R′ₖ}. After the initial step, rather than storing the message digests {M₁; . . . ; Mₖ}, the second party stores the set of responses {R₁; . . . ; Rₖ}. Therefore, the set of initial message digests are not available anymore, and a third party able to download the information stored by the second person cannot use it to uncover the shared cryptographic keys. The second person needs the PUFs or biometric images to recover the keys through the CRP mechanism.

It will be noted that both of the previously described systems require repeated, iterative hashing of physical measurement data (from PUFs or biological object data or both) many thousands of times per element of physical data, and potentially hundreds of thousands of times for full generation of keys, which may be formed as combinations of sub-keys. Other HBC protocols such as those described by Winternitz, Lamport, SPHINCS, and U.S. Pat. No. 11,496,326 also use a large number of hash cycles. While hash-based cryptographic systems have the potential to provide strong systems, even in the post-quantum computing era, the large number of hash cycles required are conventionally characterized by high latency and enormous processing loads. Improvement is warranted.

### BRIEF SUMMARY

The objective of the present disclosure is to improve upon conventional HBC protocols (e.g., the PUF or biological object-based protocols discussed above) by using much faster one-way functions, thereby allowing large numbers of successive hash cycles at lower latencies. The protocols using large number of successive hash cycles are somewhat more immune to less than perfect one-way functions. Embodiments of the invention are directed to a systems and method for subjecting bitstreams to one-way cryptographic functions in a manner that reduces processor load and decreases processor latency. Embodiments of the invention represent a significant improvement over conventional HBC techniques. Specifically, inventive embodiments solve two families of conventional problems in cryptography. First, the inventive methods support strong one-way functions, strong being defined in the relevant art (e.g., by NIST). By supporting strong one-way functions, the inventive methods support cryptographic systems that are resistant to solution by quantum computing. Second, the inventive methods decrease latency and lighten processor load by requiring fewer computational cycles. This property of the inventive methods lends those methods to use by conventional computing systems (i.e., non-quantum) systems such as conventional mobile devices.

A fundamental requirement for a one-way function is one-wayness; that is, given a hash message digest D, it should be “hard” to find an input to the function x such that H(x)=D. The Nth-degree truncated polynomial ring (NTRU) lattice-based public-key cryptosystem is considered pre-image attack resistant due to the mathematical and computational hardness of algebraic lattice problems like Learning With Errors (LWE) and the Shortest Vector Problem (SVP). The one-way functions described herein, being based fundamentally on similar operations within truncated polynomial rings, can be independently evaluated for pre-image resistance similarly to prior evaluations of NTRU, and under such evaluation, will be found to inherit the pre-image resistance of the NTRU cryptosystem and therefore meets this primary criterion for a secure cryptographic one-way function.

In one embodiment, an inventive method includes the steps of receiving an input bitstream. The input bitstream may be a password supplied by a user, a random number, a set of PUF responses, measurement data from measuring some biological object, or some combination of any of the foregoing (e.g., by XORing, concatenation, etc.). The input bitstream is preferably chosen to be or modified to have a predetermined length, such as 256 bits. The input bitstream may be modified or expanded by the addition of a binary nonce, which may be chosen to result in predetermined total length (e.g., 256 bits) when added to the input bitstream. The resulting bitstream may be transformed into a ternary stream of −1s, 0s and 1s. The ternary stream may preferably be a balanced stream where there are approximately equal numbers of −1s, 0s and 1s. The ternary stream may also be expanded with the addition of a ternary nonce. The resulting trit stream may be read as a series of polynomial coefficients enabling the generation of a polynomial. The polynomial may then be raised to a power, to a generate a second polynomial. The coefficients of the second polynomial may then be read as an output stream, and the output stream generation process may include the step of skipping or ignoring −1s, and reading out only 0s and 1s. The output stream, now a binary bitstream, may be used for any cryptographic purpose. For example, it may be applied to a PUF or as measurement instructions to a biological object to generate indicia of the output stream, which may then be stored.

### BRIEF DESCRIPTION OF THE DRAWINGS

The drawings described herein constitute part of this specification and includes example embodiments of the present invention which may be embodied in various forms. It is to be understood that in some instances, various aspects of the invention may be shown exaggerated or enlarged to facilitate an understanding of the invention. Therefore, drawings may not be to scale.

FIG. 1 depicts an exemplary computing environment in which the methods of the present invention may be practiced.

FIG. 2 illustrates the method steps of a first method of applying a one-way function to a bitstream according to an embodiment of the invention.

FIG. 3 illustrates the method steps of a second method of applying a one-way function to a bitstream according to an embodiment of the invention.

FIG. 4 illustrates the method steps of a third method of applying a one-way function to a bitstream according to an embodiment of the invention.

FIG. 5 illustrates the method steps of a fourth method of applying a one-way function to a bitstream according to an embodiment of the invention.

FIG. 6 illustrates the method steps of a fifth method of applying a one-way function to a bitstream according to an embodiment of the invention.

### DETAILED DESCRIPTION

The described features, advantages, and characteristics may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrase “in one embodiment,” “in an embodiment,” and similar language throughout this specification may, but do not necessarily, all refer to the same embodiment. References to “users” refer generally to individuals accessing a particular computing device or resource, to an external computing device accessing a particular computing device or resource, or to various processes executing in any combination of hardware, software, or firmware that access a particular computing device or resource. Similarly, references to a “server” refer generally to a computing device acting as a server, or processes executing in any combination of hardware, software, or firmware that access control access to a particular computing device or resource.

Embodiments of the invention are directed to encryption systems and methods, and in particular encryption key generation system and methods, by which output bitstreams are generated from input bitstreams by a one-way function. As used herein, a one-way function is a function that has two defining characteristics: one-wayness and low probability of collision. One-wayness refers to the property that the output of the function cannot be used to determine the input of the function. Low probability of collision refers to the property that the function produces a unique output from a given input (i.e., there is a low probability of the same output being produced from more than one input). One-way functions also preferably produce an output bitstream of a fixed, predetermined length, regardless of the size of the input bit stream. Conventional hashing algorithms such as MD4, MD5, the SHA algorithms, DSA, Whirlpool, RIPEMD and BLAKE demonstrate these properties, but for cryptographic methods employing these functions to be strong in the post-quantum era, these algorithms must be employed many thousands of times during key generation and recovery. This result is significant latency and processing load on devices, particularly on mobile devices which might not have significant processing resources.

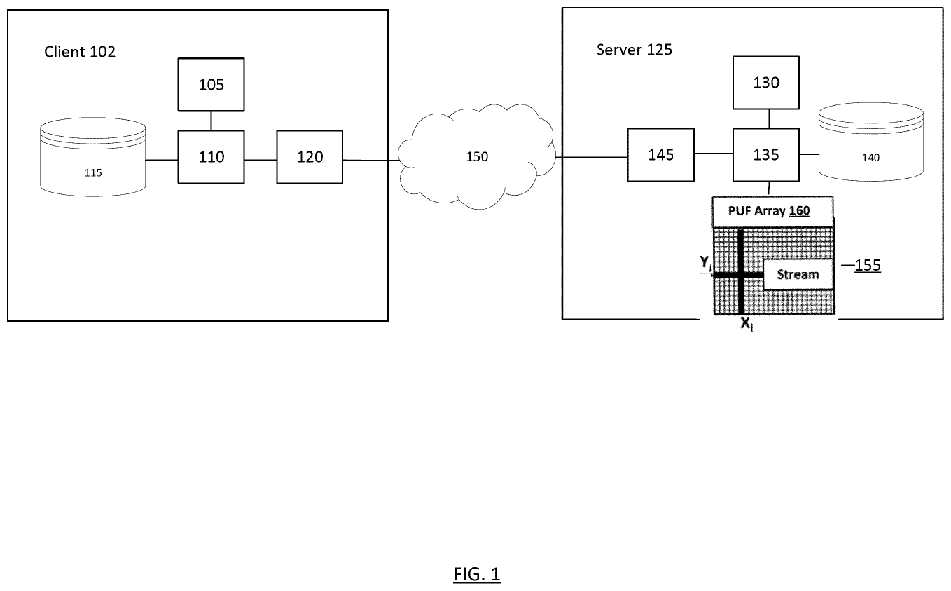

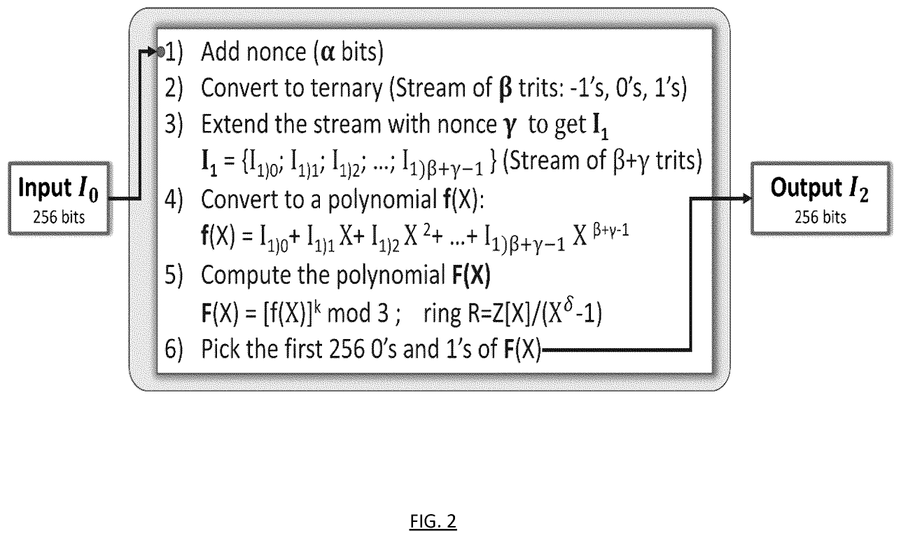

Inventive embodiments are directed to improved methods of implementing one-way functions. These methods will be described in detail in reference to FIGS. 2-5. It will be noted that these methods are usable in any computing environment applying one-way functions to input bitstreams and are most advantageous when applied in the systems described above, for example, in connection with the systems described in U.S. patent application Ser. Nos. 17/879,697 and 18/397,975, because those systems involve the iterative hashing of a bitstream potentially many thousands of times. An example computing environment for use with the disclosed methods will now be described, in connection with FIG. 1. This computing system is usable and is described in application Ser. No. 17/879,697, but it is described here for clarity.

Referring now to FIG. 1, there is shown a server 125 and a client or user 102, which may be part of a plurality of client devices configured as client 102. Server and client may be computing devices having programmable processors (110, 135). These processors may be quantum or non-quantum processors. They may be native binary or native non-binary (e.g., ternary) processors. Server and client may also have one or more input/output devices 105, 130 that are typically found with computing devices such as keyboards, mice, touch screens, stylus pads, cameras, microphones, speakers and monitors or other visual displays. Server and client may also have volatile memory (e.g., RAM), in electronic communication with their respective processors. Server and client may also have non-volatile storage 115, 140 (e.g., SSD drives, disk drives, flash storage, etc.) in electronic communication with their respective processors. Non-volatile storage may store computer code embodying computer executable instructions capable of being executed by the processors 110, 135 to carry out the various method steps discussed herein, including the method steps described below in connection with FIGS. 2-5. Server and client also may include network interfaces 120, 145, which are data transceivers supporting electronic communications via network 150 with other computing devices such as one another. Network 150 may be a wired or wireless data communication network and interfaces 120, 145 may be wired or wireless interfaces, or may include both wired and wireless interface components. Random number generators, or pseudo-random number generators, as ASICs or preferably as processes running on device processors, may also be useful and may be included in certain embodiments.

In the example of FIG. 1, server device 125 includes an addressable PUF generator (APG) 155, which itself includes an addressable array of physical unclonable function devices 160. The PUF array 160 of a server 125 is an array of electronic or other devices with measurable physical characteristics, configured in an addressable array similar to an addressable memory device such as RAM or ROM chip. Due to small variations which occur during semiconductor manufacturing or other manufacturing processes, each PUF device (and hence each PUF array 160) may be unique, even if the PUF arrays are mass-produced by a process designed to produce nominally identical devices. The PUF array 160 (shown as an addressable 2D-array of cells) of a server 125 may be accessed by the server 125 which can receive or generate challenges. The challenges can represent, or be parsed or processed to represent, measurement instructions that can be applied as stimulus to the PUF array to elicit responses, that is to say, the APG 155 responds to challenges by generating responses using measured physical characteristics of one or more PUF devices within the PUF array 160 identified by the challenge or derived from it using instructions stored by the APG 155. As an example, challenges may be a bitstream that is read to identify one or more individual addresses of PUF devices within PUF array 160, and optionally, measurement conditions for those devices. Preferably, APG 155 contains additional processing circuitry and can execute instructions for generating challenges and reading the PUF responses.

The arrangement depicted in connection with FIG. 1 may support cryptographic communication, authentication and the generation of session keys between the server and client. In one exemplary method, a client initiates an enrollment process by receiving a password, i.e., from a user using a client input/output device, or some other secret bitstream. In alternative embodiments, the client receives a previously entered password from memory. In alternative embodiments, the client perturbs an entered or previously stored password, e.g., by xoring the password with a random number, to create a new password. Client (e.g., 102) applies a one-way cryptographic function to the password. The one-way cryptographic function may preferably be a one-way function operating according to one of the embodiments discussed below, and it preferably takes the password, which may be an arbitrary length, and maps it to a fixed length output. Client 102 repeatedly applies the one-way function to the password or secret bitstream a first predetermined number of times, P₀, resulting in a message digest MD₀, which is transmitted to the server 125. In certain embodiments this enrollment procedure occurs in a secure environment. If the exponential notation H^{P0} is used to describe such a multiple application of a one-way function, the message digest may be denoted as MD₀=H^{P0}(PW). It is advantageous that the natural number P₀ be picked randomly. In certain embodiment's the client 125 includes a random number generator, which generates P₀, which preferably is a relatively large number (e.g., between 600 and 1,100).

The server 125 may store the message digest MD₀ but preferably creates some unique indicia of the message digest, which is then stored. In one embodiment, the server includes an addressable array of PUF devices and an APG, as shown, which measures some physical characteristic of the individual PUF devices and outputs the resulting measurements, that is to say that the APG can provide challenges to the PUF array and return responses. The server uses MD₀ to generate challenges and to drive its PUF and APG to generate the data stream of responses R₀. That is to say, the server derives a set of PUF challenges from MD₀, applies those challenges to its PUF, and obtains the corresponding responses. In some embodiments, server 125 may convert MD₀ into a range of addresses or indices corresponding to individual devices in the server's PUF array to measure. The resulting bitstream of responses R₀ is stored by the server for future reference.

In alternative embodiments, a non-illustrated third-party device, acting as a certificate authority (CA) is provided. The CA includes an image of one or more client PUFs. As is set forth above, a PUF image is a database of previously measurement responses for a plurality of the individual devices in the PUF array, ideally, all the devices, although some erratic devices may be ignored. In certain embodiments, a CA computing device includes an image of the PUF array on the server. The client device 102 secretly (i.e., over a trusted communication channel) sends the message digest, MD₀ to the CA, which computes (or looks up) R₀ from its PUF image. The CA may then pass R₀ to the server, while MD₀ remains secret. In such embodiments, the computational burden of the enrollment process is transferred from the server 125 to the CA. Additionally, this arrangement offers additional security because MD₀ is not transmitted in the clear, and the server 210 does not measure or query its PUF during enrollment, which increases the resistance of the server to side channel attacks directed at detecting the PUF's response. This may be advantageous when the server is exposed to a highly hostile environment.

In yet another embodiment, client 102 generates a plurality (preferably on the order of 1000) message digests MD₀. These may be generated by permuting one or more user supplied passwords with the help of random numbers generated by the RNG. By way of example, a single password could be XORed with a plurality of ˜1000 sequentially generated random numbers, resulting in a plurality of permuted passwords. Each permuted password is then iteratively subject to a one-way function, preferably according to one of the methods described below, a random number (P₀) times. Additionally, or alternatively, a series of passwords or permuted passwords is iteratively hashed a different number of times (i.e., P₀ is different for each password or permuted password). In either case, the resulting hashed passwords or permuted passwords are sent as message digests to the server (or to a CA as above). The server, or the CA, generates the corresponding R_{D}s and store them in a data base. These embodiments increase security because the client devices can constantly change their passwords, and this at a relatively small cost of increased complexity. In extreme cases, a password can be only used once to create a single session key.

A method of generating session keys for communication between a client and a server that have engaged in one of the enrollment processes discussed immediately above will now be described. To generate a client session key, the client 102 again receives a password (i.e., the secret bitstream) either from storage, or preferably from a user of the client device. The client then subjects the password/secret bitstream to a one-way function a second number of times P₁ times to compute a message digest MD₁=H^{P1}(PW). This message digest is sent to the server. The natural number P₁ may be picked randomly, such as with the client's random number generator. Preferably the second predetermined number, P₁ is considerably smaller than P₀ (e.g., in a range of 100 and 600 where P₀ is 1000). Preferably, the second predetermined number P₁ is in range of between 5 and 80% of the first predetermined number P₀. In certain embodiments, P₁ is at least 100. The server 125 uses MD₁ and its APG to find the natural number x₁ through an iterative process, generating the data stream of response R_{P1} from the message digest H^{X1}(PW) that is approximately equal to the initial data stream R₀ which was kept as reference. That is to say, server 125, using the same one-way function as employed by the client 102, continues to iteratively apply the one-way function to message digest, and apply the resulting number (e.g., as a set of PUF addresses) to its PUF, until it gets a PUF response that is equal to the initially stored response R₀. The number of times the server must apply the one-way function to the message digest, X₁, is the session key, which may be used to authenticate the client, or to generate encryption keys to support further communication between the devices. The client may also calculate this number X₁, which is the difference between P₀ and P₁.

It will be appreciated that PUF responses of the server during the key generation step mentioned immediately prior may not match the initially generated responses. That is to say, even in cases where the server has applied the one-way function to the message digest a sufficient number of times to arrive again at the initial message digest MD₀ that was received during enrollment, applying that message digest to the PUF may not return the same initially measured R₀. This is because hardware PUFs of the sort contemplated for use in this example embodiment are not perfectly deterministic. PUF devices are subject to drift, and may return different measurement values depending on changing factors such as temperature. Additionally, certain PUF devices may be erratic. For example, in the case of SRAM PUFs, certain cells may settle to a 1 state and a 0 state about half the time with repeated power-on cycles. Several strategies may be employed to deal with this issue. For example, systems operating according to inventive embodiment can characterize the server PUF beforehand and exclude the addresses of erratic cells from being included (or generated by) any message digest applied to a PUF according to the methods described herein. Moreover, the methods described herein do not require an absolute match between the matching stream R_{P1} and the initial stream R₀ as long as false acceptance rates can be ruled out. For example, a matching of 90% of the streams R_{P1} and R₀, are perfectly acceptable, thereby tolerating drifts in the physical properties of the PUF. In certain embodiments, a bit match rate of greater than 70% is acceptable. In other embodiments, bit match rates of greater than 75, 80, 85, 90 and 95% are preferred.

In the example described above, the server's PUF is used to generate indicia of the message digests, and the indicia are stored and compared for authentication. The use of a PUF for this purpose is exemplary only, and other methods are possible. For example, rather than a PUF, application Ser. No. 18/397,975 describes using biological objects and/or biological prints of biological objects for this purpose. That disclosure describes taking message digests and deriving from them measurement instructions for some biological object (e.g., spatial coordinates in an image of a biological object like a finger print), and the responses are measured image data. In both cases, message digests (or fractions thereof) are used to elicit physical measurement data, which is indicia of the message digest, and that physical measurement data is stored for later comparison. In either case, the methods disclosed above rely on the repeated application of one-way functions to message digests potentially many thousands of times. In the applications referenced above (and incorporated herein), the one-way functions are preferably hashing algorithms. The additional disclosure below will describe alternative and improved one-way functions that may be applied in the physical environment disclosed in FIG. 1, or in any of the systems disclosed in the applications referenced above.

Referring now to FIG. 2, there is shown method steps, which may be computer implemented method steps, of a general one-way function based on computations in a truncated polynomial ring modulo 3, with nonces. The steps of the method of FIG. 2 are as follows:

Step 1: The input is a binary stream I₀ that is 256 bits long (0's and 1's); The input I₀ is a binary stream of 0's and 1's, which is for example 256-bit long; an α-bit long nonce is added.

Step 2: The resulting stream is converted into a β-trit long balanced stream (−1's, 0's, 1's) [Log₂(3)≈1.585 bits are needed for a trit; β≈(256+α)/1.585 rounded].

Step 3: A nonce of γ trits is added to generate I₁.

$${I}_{1} = ( {I}_{1 ) 0} ; {I}_{1 ) 1} ; {I}_{1 ) 2} ; … ; {I}_{1 )} β + γ - 1 \}$$

Step 4: The stream of trits I₁ is converted into a polynomial f(X) of β+γ variables, using the stream of trits as coefficient:

$$f ( X ) = {I}_{1 ) 0} + {I}_{1 ) 1} X + {I}_{1 ) 2} {X}^{2} + … + {I}_{1 ) β + γ - 1} {X}^{β + γ - 1}$$

Step 5: The polynomial f(X) exponent k is computed, with k coprime to 3, using balanced modulo 3, in the truncated polynomial ring, R=Z[X]/(X^{δ}−1) with δ prime and δ>384:

F(X)=[f(X)]^{k} mod 3

Step 6: The output stream I₂ of the one-way function consists of the first 256 coefficients of F(X) that are either 0's or 1's, while dropping the −1's, and remaining coefficients.

Some conditions exist to be able to get a 256-bit long balanced stream I₀, where balanced refers to the bitstream having equal or approximately equal numbers of 0's and 1's. F(X) should be at least ⅓ longer, therefore S should be greater than 384. The number of variables k(β+γ) should also be greater than 384. This is achieved by making α, γ, and k large enough. K should also be co-prime with 3. As shown in FIG. 1, it is assumed that such conditions exist for a one-way function generating a 256-bit long stream I₂ from a 256-bit long stream I₀. This protocol also generates an output of fixed length of 256 bits when I₀ contain more than 256 bits.

To be practically usable in cryptography, the one-way function should be secure with properties like the ones expected in hash functions. The most important property is the one-way aspect, the knowledge of the output I₂ should not disclose the input I₀.

If α, γ, and k are large enough the one-way function always generates a 256-bit long stream I₂, regardless of the number of bits of the input stream I₀. Such an example of this configuration is when α=256, γ=256, and k=2.

To enhance security the addition of nonces α and should be done by mixing the 256 bits of I₀ and the stream of bits from a. For example, not limited to, the bits from α are inserted between every other bit from I₀. Another approach is to transform the stream I₀ into a polynomial that is multiplied with a second polynomial formed with the stream of bits from α. Similar schemes can enhance security during the addition of nonce γ into stream β to generate the stream I₁.

The security of the one-way functions described in this disclosure can be adjusted up or down by increasing or decreasing the size of the parameters α, γ, and k. When these functions are subjected to large numbers of cycles, the important one-way aspect is the one achieved after the multiple cycles. In such a case, it is possible to decrease the size of the parameters α, γ, and k without compromising the one-way aspect, thereby improving latencies. Conversely, if the one-way function is only used once, it is preferable that these parameters are increased.

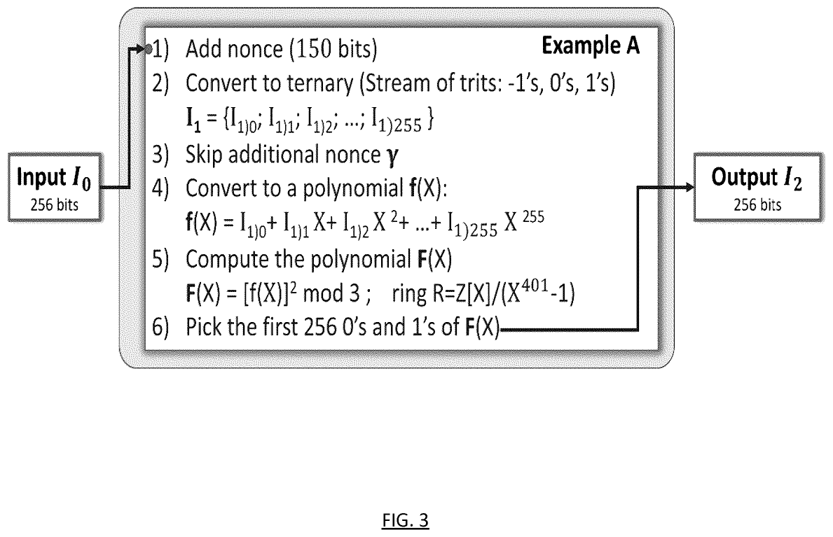

Several variations of the method described in connection with FIG. 2, for various exemplary values of α, γ, and k will now be described in connection with FIGS. 3-6. FIG. 3 provides an example where α=150, γ=0, k=2, and δ=401.

Step 1: The input I₀ is a binary stream of 0's and 1's, which is, for example, 256-bit long; a 150-bit long nonce is added.

Step 2: The stream is converted into a 256-trit long balanced stream (−1's, 0's, 1's):

I₁={I₁₎₀;I₁₎₁;I₁₎₂; . . . ; I₁₎₂₅₅}

Step 3: Skip

Step 4: The stream of trits I₁ is converted into a polynomial f(X) of 256 variables, using the stream of trits as coefficient:

$$f ( X ) = {I}_{1 ) 0} + {I}_{1 ) 1} + {I}_{1 ) 2} {X}^{2} + … + {I}_{1 ) 255} {X}^{255}$$

Step 5: The polynomial f(X) exponent 2 is computed, using balanced modulo 3, in the truncated polynomial ring, R=Z[X]/(X⁴⁰¹−1):

F(X)=[f(X)]² mod 3

Step 6: The stream I₂ consists of the first 256 coefficients of F(X) that are either 0's or 1's.

A variation of this scheme is the one where α=150 and γ=0, are replaced by α=0 and γ=94. The conversion of I₀ in trits takes 162 trits, therefore I₁'s length remain at 256 trits.

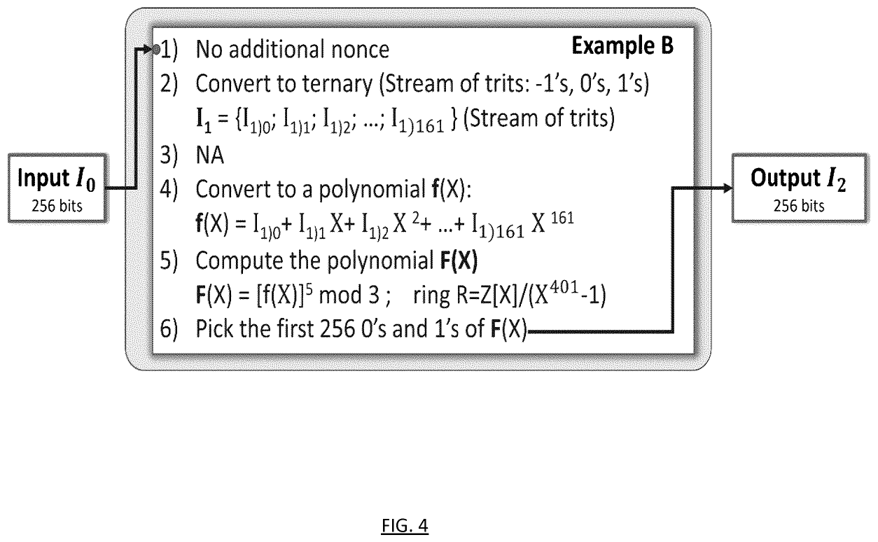

FIG. 4 illustrates another example, where α=0, γ=0, k=5, and δ=401.

Step 1: The input I₀ is a 256-bit long binary stream (0's and 1's).

Step 2: The stream is converted into a 162-trit long balanced stream (−1's, 0's, 1's):

I₁={I₁₎₀;I₁₎₁;I₁₎₂; . . . ; I₁₎₁₆₁}

Step 3: Skip

Step 4: The stream of trits I₁ is converted into a polynomial f(X) of 162 variables, using the stream of trits as coefficient:

$$f ( X ) = {I}_{1 ) 0} + {I}_{1 ) 1} + {I}_{1 ) 2} {X}^{2} + … + {I}_{1 ) 261} {X}^{261}$$

Step 5: The polynomial f(X) exponent 5 is computed, using balanced modulo 3, in the truncated polynomial ring, R=Z[X]/(X⁴⁰¹−1):

F(X)=[f(X)]⁵ mod 3

Step 6: The stream I₂ consists of the first 256 coefficients of F(X) that are either 0's or 1's.

As done in the FIG. 3 protocol, a nonce can be added to I₀, I₁, or both.

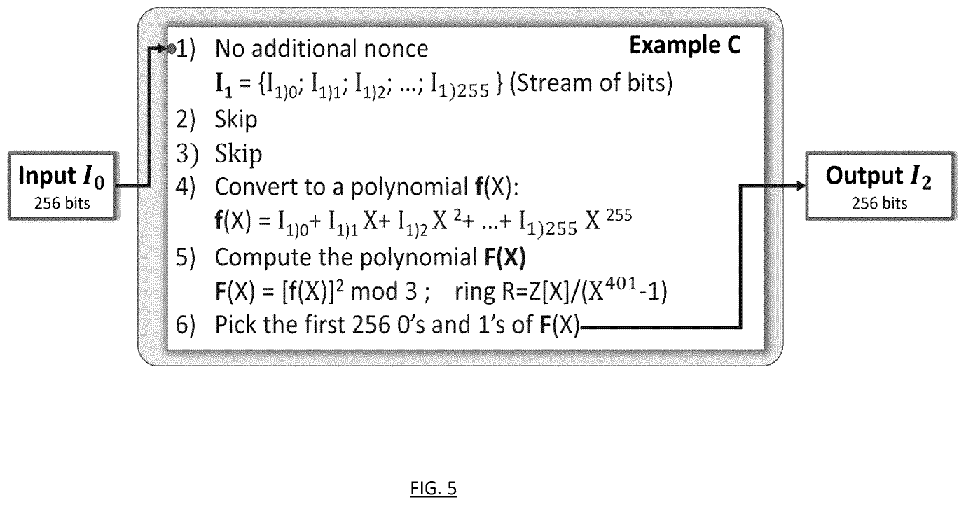

FIG. 5 illustrates yet another, simpler example where α=0, γ=0, k=2, and δ=401.

Step 1: The input I₀ is a 256-bit long binary stream (0's and 1's):

I₀={I₀₎₀;I₀₎₁;I₀₎₂; . . . ; I₀₎₂₅₅}

Step 2: Skip

Step 3: Skip

Step 4: The stream of bits I₀ is converted into a polynomial f(X) of 256 variables, using the stream of bits as coefficient:

$$f ( X ) = {I}_{0 ) 0} + {I}_{0 ) 1} + {I}_{0 ) 2} {X}^{2} + … + {I}_{0 ) 255} {X}^{255}$$

Step 5: The polynomial f(X) exponent 2 is computed, using balanced modulo 3, in the truncated polynomial ring, R=Z[X]/(X⁴⁰¹−1):

F(X)=[f(X)]² mod 3

Step 6: The stream I₂ consists of the first 256 coefficients of F(X) that are either 0's or 1's.

As done in the FIG. 3 protocol, a nonce can be added to I₀, I₁, and k can be greater than 2.

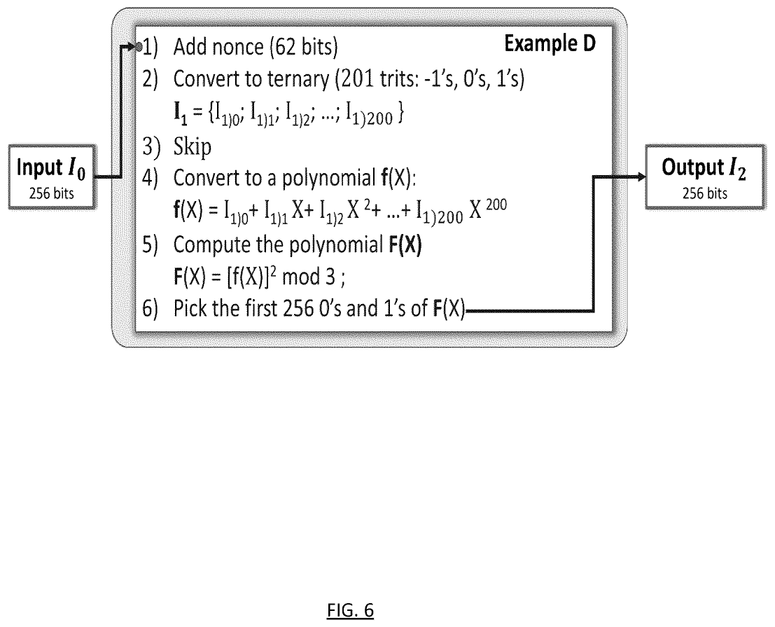

FIG. 6 illustrates yet another example, where, α=62, γ=0, k=5, and δ=na.

Step 1: The input I₀ is a 256-bit long binary stream (0's and 1's), add 62-bit nonce.

Step 2: The stream is converted into a 201-trit long balanced stream (−1's, 0's, 1's):

I₁={I₁₎₀;I₁₎₁;I₁₎₂; . . . ; I₁₎₂₀₀}

Step 3: Skip

Step 4: The stream of trits I₁ is converted into a polynomial f(X) of 201 variables, using the stream of trits as coefficient:

$$f ( X ) = {I}_{1 ) 0} + {I}_{1 ) 1} + {I}_{1 ) 2} {X}^{2} + … + {I}_{1 ) 200} {X}^{200}$$

Step 5: The polynomial f(X) exponent 2 is computed, using balanced modulo 3:

F(X)=[f(X)]² mod 3

Step 6: The stream I₂ consists of the first 256 coefficients of F(X) that are either 0's or 1's.

As done in the FIG. 3 example, a nonce can be added to I₁, and k can be different than 3.

The computations of the polynomials raised to a power of k in a truncated polynomial ring R=Z[X]/(X^{δ}−1), as presented previously, are extremely fast. However, other computations as also effective, such as the ones done in the truncated polynomial rings, R=Z[X]/(X^{δ}+1), and R=Z[X]/(X^{δ}+φ); the parameter δ is a natural number greater than the length of the output stream, and the parameter φ is a small integer number. The computations can also be done in any finite field R=Z[X]/P(X), with P(X) being an irreducible polynomial of the field.

The one-way function can also operate as an extended output function by increasing the numbers k, and δ. For example, with k=23, and δ=4000, a 2560-bit long output stream can be generated from the one-way function.

The one-way function generation methods described are advantageous in that they demonstrate strong one-wayness while requiring relatively few computational cycles. Certain variations on these methods that provide further improvement, which has been verified by experimentation, will now be described.

Fast Polynomial Multiplication In Ring R=Z₃[X]/(X^{δ}−1)

In this optional and alternative protocol, when the data stream is converted to trits (Step 2, in the protocols above), it will represent a polynomial P[X]∈R=Z₃[X]/(X^{δ}−1) that needs to be taken to some power k. The naïve approach to finding (P[X])^{k} has a complexity of O(n²). To combat this, a fast Fourier transform (FFT) and number theoretic transform (NTT) can be used to speed up the process. The current algorithm consists of 4 stages:
1. FFT the polynomial array.
2. Apply pointwise multiplication in the FFT space.
3. Inverse FFT the pointwise multiplied array and apply modulo 3.
4. Truncate the polynomial array so it is an element of ring R (NTT step)

The reason for using FFT/NTT an FFT has a computational complexity of O(n log(n)). Once the transformation has been applied pointwise multiplications in the transformed space can then be applied followed by application of inverse FFT modulo 3 to get (P[X])k. However, this new polynomial is not an element of R so it truncated using the fact that X^{nδj}=X^{j} in ring R for n∈N and j∈Z_{δ}. So far there have been 2 truncation methods attempted:
1. Padding the FFT result with zeros until it has a length of nδ. After that reshape the padded array to be an n×δ array then sum the columns modulo 3.
2. Preallocating space for an array P of size δ, padding the FFT result with zeros until it has a length of nδ, then using array slicing and indexing to sum and store every δth term into array P.

The methods described above has been experimentally confirmed to exhibit low latency. A python implementation for squaring polynomials in ring R resulted in computation of the output string in the 30-50 μs range using numba's just in time compiler and numpy's built in array methods. For a power k=5 using the same implementation, results at about 210 μs were obtained.

Additionally, variations on the methods disclosed herein are possible. One such is a variation of the NTRU-based one-way function which turns the function H(x)=D into a keyed hash function H(x, K)=D (also known as a hash-based message authentication code), which can confer both integrity and authenticity to digested messages, in addition to increasing the overall security level of the function. Under this method, a key is integrated as an additional step in the hash algorithm; it could be used to set an initial state for the rest of the algorithm to start from, or it could be used to add noise somewhere in the middle of the convolutional part of the algorithm, or it could be involved in a final step before output is produced. In such a variation, the security of the one-way function would then rely both on the cryptographic strength of the underlying function and the secrecy of the key; correctly implemented, this variant would be even harder for an attacker to compute backwards because of the dependence of the digest on both the original data and the key.

Additionally, the nonce described above can be “meshed” into the data stream (i.e., instead of appending the nonce to the end, every other bit/trit is from the generated nonce).

When adding the nonce, once the length of data stream S is known, each bit/trit can be indexed such that index i∈Z_(S−1). A random index can be chosen to act as the starting place for the insertion of the nonce. This technique can be combined meshing if the length of the data stream is larger than the length of the nonce.

Additionally, a successive squaring method can be applied (like how modular exponentiation is done) to speed up powers of k>3.

The input “I” can be used as a seed to the PRNG that generates the nonce. This approach guarantees that each nonce is intrinsically linked to its corresponding input, ensuring the hash value for a given input remains consistent.

Additionally, the trit addition can be converted to fast binary operations. A very important base operation of polynomial multiplication is polynomial addition. For a fast multiplication algorithm, every non-zero trit within one of the polynomials requires an addition with the other polynomial and an accumulating polynomial. Since addition is a core operation, it needs to be fast and take advantage of modern hardware. For polynomial addition modulo 3 with no carry over, each operation can be performed independently on the two bits that make a trit. By performing a k-map reduction on the two output bits, trit addition can be reduced to operating on the 4 input bits creating the two output bits in the final trit. Due to no carry over bits, this operation can be trivially replicated across all bits in parallel allowing either hardware or SIMD to quickly perform the calculations. This technique will also allow us to determine the best underlying presentation of the 3rd trit state by finding quick presentation requires the least bit operations. Ultimately, a k-map reduction will allow for great performance on software as there is no dependences between the bits representing the final ternary number. This will smoothly translate into a hardware representation with no major changes requiring allowing for N size ternary addition to happen in constant time.

The disclosure above has generally described improved methods for reducing the latency and lightening computational loads when computing one-way cryptographic functions. While these methods are applicable to one-way functions generally, it is specifically contemplated that they will be advantageously employed in cryptographic systems involving physical sources of bitstreams, such as PUFs and biometric data. For example, in the pseudo-homomorphic methods described above, a secret input bitstream is repeatedly hashed for key generation and recovery, and indicia of hashed output bitstreams is generated by applying the hashed bitstream as a PUF challenge or biological measurement instructions, and the resulting output is stored. In these systems, the one-way functions described herein can replace conventional hashing algorithms. Additionally, the input bitstream itself may be generated from PUFs or biometric or biometric print data, rather than from passwords.

It should be understood that unless explicitly stated or otherwise required, the features disclosed in embodiments explicitly described herein and elsewhere in this disclosure may be used in any suitable combinations. Other embodiments and uses of the above inventions will be apparent to those having ordinary skill in the art upon consideration of the specification and practice of the invention disclosed herein. It should be understood that features listed and described in one embodiment may be used in other embodiments unless specifically stated otherwise. The specification and examples given should be considered exemplary only, and it is contemplated that the appended claims will cover any other such embodiments or modifications as fall within the true scope of the invention.

The invention claimed is:

1. A method of generating an output bitstream from an input bitstream in a computing the device, the method comprising:
receiving an input bitstream of binary bits;
converting the input bitstream into a ternary stream;
converting the ternary stream into a first polynomial, in which the coefficients of the first polynomial are values encoded in the ternary stream;
raising the first polynomial to a power of k using balanced modulo 3, wherein k is selected to be a co-prime to 3, resulting in a second polynomial; and
selecting coefficients of the second polynomial as an output bitstream.

2. The method of claim 1, wherein the input bitstream is 256-bits long.

3. The method of claim 1, wherein selecting coefficients of the second polynomial as an output bitstream comprises selecting a sequence of 0s and 1s as the output bitstream while omitting −1s.

4. The method of claim 1, wherein selecting coefficients of the second polynomial as an output bitstream further comprises selecting, in sequence, 0s and 1s up to a predetermined bit length as the output bitstream, while omitting −1s.

5. The method of claim 1, wherein converting the input bitstream into a ternary stream comprises converting the input bitstream into a balanced ternary stream of −1s, 0s and 1s.

6. The method of claim 1, further comprising adding a binary nonce to the input bitstream prior to conversion to a ternary stream.

7. The method of claim 6, wherein adding a binary nonce to the input bitstream prior to conversion to a ternary stream comprises adding a binary nonce of sufficient length such that the binary nonce together with the input bitstream have a combined length of a predetermined length.

8. The method of claim 7, wherein the predetermined length is 256 bits.

9. The method of claim 1, further comprising adding a ternary nonce to the ternary stream.

10. The method of claim 1, wherein raising the first polynomial to a power of k using balanced modulo 3, wherein k is selected to be a co-prime to 3, resulting in a second polynomial comprises using truncated polynomial rings, R=Z[X]/(X^{δ}−1), R=Z[X]/(X^{δ}+1), R=Z[X]/(X^{δ}+φ), wherein the parameter δ is a natural number greater than the length of the output bitstream, and the parameter φ is an integer number.

11. The method of claim 1, wherein raising the first polynomial to a power of k using balanced modulo 3, wherein k is selected to be a co-prime to 3, resulting in a second polynomial comprises using a finite field R=Z[X]/P(X), with P(X) being an irreducible polynomial of the field.

12. The method of claim 1, further comprising using the output bitstream as at least part of a PUF challenge.

13. The method of claim 12, further comprising, receiving a PUF response corresponding to the PUF challenge from a PUF and storing the PUF response.

14. The method of claim 1, further comprising using the output bitstream to derive measurement instructions applicable to a biological object or image data regarding a biological object.

15. The method of claim 14, further comprising measuring the biological object or image data regarding the biological object in accordance with the measurement instructions and storing resulting measurement data.

16. A method of transforming an input bitstream into an output bitstream, the output bitstream to be used for cryptographic key generation, the method comprising:
receiving a balanced input bitstream of binary bits;
converting the input bitstream into a polynomial, in which the coefficients are values encoded in the binary bitstream;
raising the polynomial to a power of k using balanced modular 3, wherein k is co-prime to 3; and
selecting coefficients of the resulting polynomial as an output bitstream.

17. The method of claim 16, further comprising using the output bitstream as at least part of a PUF challenge.

18. The method of claim 17, further comprising, receiving a PUF response corresponding to the PUF challenge from a PUF and storing the PUF response.

19. The method of claim 16, further comprising using the output bitstream to derive measurement instructions applicable to a biological object or image data regarding a biological object.

20. The method of claim 19, further comprising measuring the biological object or image data regarding the biological object in accordance with the measurement instructions and storing resulting measurement data.
